(19) United States
(12) Patent Application Publication
(10) Pub. No.: US 2022/0406087 A1
(43) Pub. Date: Dec. 22, 2022

(54) ULTRASONIC BIOMETRIC IMAGING DEVICE WITH REFLECTION REDUCTION

(71) Applicant: Fingerprint Cards Anacatum IP AB, Göteborg (SE)

(72) Inventors: Cuong Hung NGUYEN, HORTEN (NO); Jonas JENSEN, COPENHAGEN V (DK); Christian GRØNNEGAARD, COPENHAGEN (DK); Farzan GHAVANINI, MÖLNDAL (SE); Agnieszka Bicz, WROCLAW (PL); Roy HANSEN, DRAGØR (DK)

(73) Assignee: Fingerprint Cards Anacatum IP AB, Göteborg (SE)

(21) Appl. No.: 17/776,645

(22) PCT Filed: Nov. 3, 2020
(86) PCT No.: PCT/SE2020/051057

§ 371 Date: May 13, 2022

(30) Foreign Application Priority Data
Nov. 19, 2019 (SE) 1951333-2

(51) Int. Cl. G06V 40/13; G10K 11/16; G10K 11/02

(52) U.S. Cl. CPC G06V 40/1306; G10K 11/16; G10K 11/02

(57) ABSTRACT

An ultrasonic biometric imaging device comprising: a cover structure having an exposed outer surface, wherein at least a portion of the exposed outer surface forms a sensing surface of the ultrasonic biometric imaging device; and a plurality of ultrasonic transducers attached to an edge portion of the cover structure and configured to emit an ultrasound wave into the cover structure; the cover structure further comprising a reflection reducing layer arranged at a bottom surface of the cover structure, wherein the reflection reducing layer is configured to reduce an amplitude of ultrasonic wave reflections at the bottom surface of the cover structure.

### FIELD OF THE INVENTION

The present invention relates to an ultrasonic biometric imaging device. In particular, the invention relates to an ultrasonic biometric imaging device for biometric imaging on a planar surface such as a cover glass of a display panel.

### BACKGROUND OF THE INVENTION

Biometric systems are widely used as means for increasing the convenience and security of personal electronic devices, such as mobile phones etc. Fingerprint sensing systems in particular are now included in a large proportion of all newly released personal communication devices, such as mobile phones.

Due to their excellent performance and relatively low cost, capacitive fingerprint sensors have been used in an overwhelming majority of all biometric systems.

Among other fingerprint sensing technologies, ultrasonic sensing also has the potential to provide advantageous performance, such as the ability to acquire fingerprint (or palmprint) images from very moist fingers etc.

One class of ultrasonic fingerprint systems of particular interest are systems in which acoustic signals are transmitted along a surface of a device element to be touched by a user, and a fingerprint (palmprint) representation is determined based on received acoustic signals resulting from the interaction between the transmitted acoustic signals and an interface between the device member and the user's skin.

Such ultrasonic fingerprint sensing systems, which are, for example, generally described in US 2017/0053151 may provide for controllable resolution, and allow for a larger sensing area, which may be optically transparent, without the cost of the fingerprint sensing system necessarily scaling with the sensing area and thereby allowing integration of ultrasonic fingerprint sensors in a display of a device.

However, current solutions struggle to provide a high-resolution biometric image with the large coverage area required of the full in-display screen, in part due to the reduction is signal strength with increasing distance to the object to be imaged.

Accordingly, there is a need for improved biometric imaging systems for large area biometric imaging using ultrasonic technology.

### SUMMARY

In view of above-mentioned and other drawbacks of the prior art, it is an object of the present invention to provide an improved biometric imaging system where undesirable reflections of the ultrasonic wave are reduced.

According to a first aspect of the invention, there is provided an ultrasonic biometric imaging device comprising: a cover structure having an exposed outer surface, wherein at least a portion of the exposed outer surface forms a sensing surface of the ultrasonic biometric imaging device; and a plurality of ultrasonic transducers attached to an edge portion of the cover structure and configured to emit an ultrasound wave into the cover structure; the cover structure further comprising a reflection reducing layer arranged at a bottom surface of the cover structure and adjacent to the ultrasonic transducers, wherein the reflection reducing layer is configured to reduce an amplitude of ultrasonic wave reflections at the bottom surface of the cover structure.

In the present context, the cover structure may be made from any material capable of carrying the ultrasonic waves emitted by the ultrasonic transducers. The cover structure further comprises an outer surface which can be touched by a biometric object such as a finger or a palm, and portion of the outer surface where an image can be captured may also be referred to as a sensing surface.

The ultrasonic transducers typically comprise a piezoelectric material generating an ultrasonic signal in response to an electric field applied across the material by means of the top and bottom electrodes. In principle, it is also possible to use other types of ultrasonic transducers, such as capacitive micromachined ultrasonic transducers (CMUT). The ultrasonic transducers will be described herein as transceivers being capable of both transmitting and receiving ultrasonic signals. However, it is also possible to form a system comprising individual and separate ultrasonic transmitters and receivers.

The reflection reducing layer is a layer specifically configured and selected to reduce the reflection of ultrasonic waves at the bottom surface of the cover structure in order to reduce the amount of reflected ultrasonic waves reaching the transducer and/or the sensing area. The function of the ultrasonic biometric imaging device is critically dependent on the propagation of waves from the transmitters at the edge of the cover structure to an active sensing region, and on the propagation of scattered waves from the biometric target back to the transducer. Thereby, any ultrasonic wave reflected at the bottom surface of the cover structure will disturb the resulting image, and it is thus desirable to minimize reflections at the bottom surface. In order to reduce and/or minimize the reflections at the bottom surface, the reflection reducing layer may be configured to utilize several mechanisms such as acoustic attenuation in the reflection reducing layer and scattering at the interface between the cover structure and the reflection reducing layer.

In view of the above, the present invention is based on the realization that the performance of an ultrasonic biometric imaging device can be improved by providing a specifically tailored reflection reducing layer at the bottom of the cover structure in which the ultrasonic waves propagate. Moreover, the reflection reducing layer is preferably configured to reduce the amplitude of any ultrasonic wave reaching or otherwise interacting with the reflection reducing layer, such as mode-converted waves, parasitic waves, dispersed waves and the like so that any undesired wave is reduced or eliminated.

The reflection reducing layer is located adjacent to the ultrasonic transducers and is thus non-overlapping with the ultrasonic transducers. This has the advantage that the reflection reducing layer can be manufactured and attached to the cover structure separately from the ultrasonic transducers.

Moreover, the reflection reducing layer is preferably located in an area of the surface structure opposite the sensing surface, i.e. underneath the cover structure opposite the exposed top side of the cover structure. The reflection reducing layer is preferably arranged to cover a major portion of the bottom surface of the cover structure so that effective reflection reduction can be achieved for all location of a finger placed on the sensing surface. For example, the reflection reducing layer may be arranged to cover a bottom surface of the cover structure corresponding to at least 50% of the sensing surface, more preferably at least 75%, and in some embodiments 100% of the area of the sensing surface.

As will be outlined in further detail in the following, the reflection reducing layer should be interpreted to include any structure, element, material or material combination located at the bottom surface of the cover structure and which is specifically tailored to reduce reflections of the ultrasonic waves used in biometric imaging.

According to one embodiment of the invention, the reflection reducing layer may comprises a damping layer attached to the bottom surface of the cover structure, the damping layer comprising a plurality of first area portions having a first acoustic property, and a plurality of second area portions having a second acoustic property different from the first acoustic property. The damping layer is thereby configured to reduce the amplitude of an ultrasonic wave being reflected at the bottom surface of the cover structure. The acoustic property may be the acoustic impedance of the material, which is a combination of speed of sound in the material and density of the material, and which also depends on the reflection coefficient at the interface between the cover structure and the damping layer. The reflection coefficient is a function of the angle of incidence and the material properties of the cover structure and the damping layer. The acoustic property may also be the acoustic attenuation in the material of which the damping layer is formed. The acoustic properties of the first and second area portions of the damping layer can for example be adjusted using filler particles, air bubbles, or materials with different density, where the different materials may be epoxies, adhesives, acrylates etc. The damping layer preferably has an acoustic impedance which is the same as or as close as possible to the acoustic impedance of the cover structure, at least in a region close to the ultrasonic transducers. Moreover, the acoustic attenuation of the damping layer should be as high as possible in order to reduce the amplitude of ultrasonic waves reaching the damping layer.

According to one embodiment of the invention, the reflection reducing layer comprises a damping layer attached to the bottom surface of the cover structure, the damping layer having an acoustic impedance similar to the acoustic impedance of the cover structure in a region adjacent the ultrasonic transducers, and where the acoustic impedance of the damping layer is decreasing with increasing distance from the ultrasonic transducers. The damping layer may for example have an acoustic impedance which is the same as the acoustic impedance of the cover structure in a portion of the damping layer closest to the ultrasonic transducers, i.e. adjacent to the ultrasonic transducers. The acoustic impedance may then decrease gradually or stepwise with increasing distance from the ultrasonic transducers. The damping layer may thereby be referred to as a horizontally graded layer, or it may comprise a plurality of area portions as described above, where an area portion closer to the ultrasonic transducers have a higher acoustic impedance compared to area portions further away from the ultrasonic transducers.

According to one embodiment of the invention, the reflection reducing layer may comprise a first acoustic damping layer in contact with the bottom surface of the cover structure and a second acoustic damping layer arranged in contact with the first acoustic damping layer, wherein the acoustic properties of the first acoustic damping layer are different than the acoustic properties of the second acoustic damping layer. Thereby, the reflection reducing layer may consist of two or more sub-layers. In order to maximize the reflection reduction, it is desirable to gradually change the acoustic impedance of the acoustic damping layers from a value close to or the same as the acoustic attenuation of the cover structure for the layer closest to the cover structure, to a value which is closer to the acoustic attenuation value of an underlying layer on the opposing side of the reflection reducing layer, such as an adhesive used for display bonding. The reflection reducing layer can thereby be referred to a stepwise or gradually graded layer in the vertical direction. That way, more ultrasonic waves will be allowed to enter the damping layers where they are attenuated. The gradual change in acoustic impedance in a direction away from the cover glass may be achieved by using a plurality of damping layers having different acoustic impedance, or by a graded damping layer having a changing acoustic impedance with increasing distance from the cover structure.

According to one embodiment of the invention, the second acoustic damping layer of the aforementioned reflection reducing layer may be an optically clear adhesive layer. Thereby, the adhesive is preferably selected so that the adhesive layer both contributes to the reflection reduction as well as acting as an adhesive for attaching the cover structure to another object such as a display panel.

According to one embodiment of the invention, the reflection reducing layer may comprise a first acoustic damping layer in contact with the bottom surface of the cover structure and a second acoustic damping layer arranged in contact with the first acoustic damping layer, wherein at least one of the first and second acoustic damping layer comprises a plurality of first area portions having a first acoustic property, and a plurality of second area portions having a second acoustic property different from the first acoustic property.

According to one embodiment of the invention, the reflection reducing layer may advantageously comprise a rough bottom surface of the cover structure, the roughness of the bottom surface being configured to scatter ultrasonic waves reaching the bottom surface. Accordingly, the reflection reducing layer may at least in part be formed by and comprise the bottom surface of the cover structure itself. The roughness of the interface is preferably formed by features having a size approximately equal to or smaller than the acoustic wavelength in the cover structure. The acoustic wavelength may for example be in the range of 50 μm to 500 μm and the roughness may thus be in the same range. It is however possible to achieve an advantageous reflecting damping effect for a surface roughness comprising features having a size outside of the specified range.

According to one embodiment of the invention, the reflection reducing layer comprises a first acoustic damping layer in contact with the bottom surface of the cover structure and a second acoustic damping layer arranged in contact with the first acoustic damping layer, wherein the acoustic properties of the first acoustic damping layer are different from the acoustic properties of the second acoustic damping layer and wherein an interface between the first and second acoustic damping layer is rough, the roughness of the interface being configured to scatter ultrasonic waves reaching the interface. Thereby, the desired reflection reduction can be achieved through a combination of a rough interface between two layers and by two layers having different acoustic properties. The roughness of the interface may preferably comprise features having a size in the range of 50 μm to 500 μm.

According to one embodiment of the invention, the transducers are arranged in contact with the cover structure so that emitted ultrasound waves are propagating in the plane of the cover structure. Since it is desirable to minimize reflections at the bottom surface, the propagation of the ultrasonic waves should preferably take place in the plane of the cover structure.

According to one embodiment of the invention, the cover structure has a curved edge portion, and the transducers are arranged at an end portion of the curved edge portion. Thereby, the ultrasonic wave can be injected into the cover structure at a surface where the transducers are arranged and be guided by the curved edge portion to subsequently propagate in the plane of the cover structure with a minimum of reflections at the bottom surface of the cover structure.

According to one embodiment of the invention, the cover structure has a sloped edge portion with a slope in relation to a surface plane of the cover structure, and wherein the transducers are arranged at a bottom surface of the cover structure opposite the sloped surface of the sloped edge portion such that emitted ultrasound waves are reflected by the sloped surface and into the cover structure, preferably in a direction parallel to the surface plane of the cover structure. Here, the transducers can be arranged at the bottom surface of the cover structure so that the emitted ultrasonic wave is redirected by the sloped surface to subsequently propagate in the plane of the cover structure with a minimum of reflections at the bottom surface of the cover structure.

According to an example embodiment, the location of the ultrasonic transducers are non-overlapping with the sensing surface. For example, the transducers may be arranged on one or more sides of a sensing surface along the periphery of the cover structure so as to be in the way of other elements which may need to be attached to the bottom of the cover structure at the location of the sensing surface. The surface area of the cover structure where biometric imaging is possible may be referred to as the active sensing surface or active sensing area.

According to one embodiment of the invention, the cover structure may comprise a recess at the bottom surface, and wherein the reflection reducing layer is arranged in the recess of the cover structure. By means of a recess, trench, cutout or the like in the cover structure, it is possible to reduce the overall thickness of the ultrasonic biometric imaging device since the reflection reducing layer does not have to add to the thickness of the cover structure. Moreover, the reflection reducing layer is advantageously arranged in the recess of the cover structure such that the reflection reducing layer and the cover structure forms a planar bottom surface, which would be advantageous from a manufacturing perspective since a cover structure with a reflection reducing layer would exhibit the same thickness as a cover structure without a reflection reducing layer.

According to one embodiment of the invention, the ultrasonic biometric imaging device may further comprise a display panel attached to a bottom surface of the reflection reducing layer. The reflection reducing layer and the cover structure would then have to be at least partially transparent so as to not distort or attenuate the light emitted by the display panel. The cover structure may for example, be a display cover glass.

There is also provided an electronic user device comprising an ultrasonic biometric imaging device according to any one of the preceding embodiments, where the cover structure of the ultrasonic biometric imaging system may be a display glass of the electronic user device. The display may be any one of a number of known display types, such an OLED, LED, LCD, AMOLED or the like as long as the display comprises a cover structure such as a cover glass which is capable of ultrasonic wave propagation.

Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

These and other aspects of the present invention will now be described in more detail, with reference to the appended drawings showing an example embodiment of the invention, wherein:

FIGS. 1A-B schematically illustrate a biometric imaging device according to an embodiment of the invention;

FIG. 2 schematically illustrates an ultrasonic biometric imaging device comprising a reflection reducing layer according to an embodiment of the invention;

FIG. 3 schematically illustrates an ultrasonic biometric imaging device comprising a reflection reducing layer according to an embodiment of the invention;

FIG. 4 schematically illustrates an ultrasonic biometric imaging device comprising a reflection reducing layer according to an embodiment of the invention;

FIG. 5 schematically illustrates an ultrasonic biometric imaging device comprising a reflection reducing layer according to an embodiment of the invention;

FIG. 6 schematically illustrates an ultrasonic biometric imaging device comprising a reflection reducing layer according to an embodiment of the invention;

FIG. 7 schematically illustrates an ultrasonic biometric imaging device according to an embodiment of the invention;

FIG. 8 schematically illustrates an ultrasonic biometric imaging device according to an embodiment of the invention; and

FIG. 9 schematically illustrates features of an ultrasonic biometric imaging device according to an embodiment of the invention.

### DETAILED DESCRIPTION OF EXAMPLE EMBODIMENTS

In the present detailed description, various embodiments of the device according to the present invention are mainly described with reference to an ultrasonic biometric imaging device configured to acquire an image of a biometric feature such as a fingerprint or palmprint when a finger or a palm is placed in contact with an exposed outer surface of a user device, also referred to as the touch surface. The touch surface may for example be a surface of a display cover glass in a smartphone, tablet or the like. However, the described biometric imaging device can equally well be implemented in other devices, such as an interactive TV, meeting-table, smart-board, information terminal or any other device having a cover structure where ultrasonic waves can propagate. Since the transducers can be arranged at the periphery of an active touch surface, the described method can also be employed in e.g. an interactive shop window or a display cabinet in a store, museum or the like. The biometric object may in some applications be the cheek or ear.

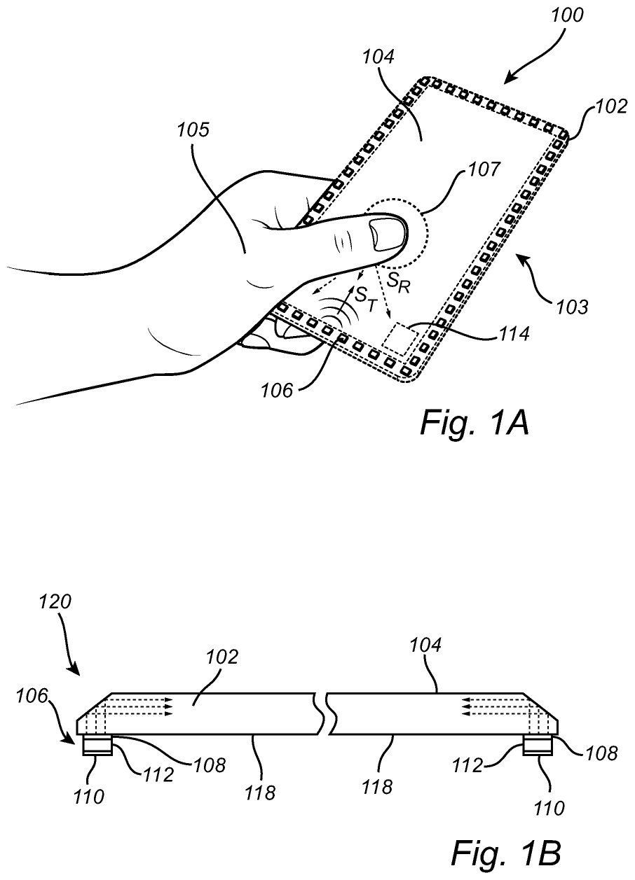

FIG. 1A schematically illustrates an ultrasonic biometric imaging system 100 integrated in an electronic device in the form of a smartphone 103. The illustrated smartphone 100 comprises a display panel having a cover structure 102 in the form of a cover glass 102. The cover glass 102 defines an exterior surface 104 configured to be touched by a finger 105, herein referred to as the touch surface or sensing surface. The cover structure 102 is here illustrated as a transparent cover glass of a type commonly used in a display panel of the smartphone 103. However, the cover structure 102 may equally well be a non-transparent cover plate as long as the acoustic properties of the cover structure 102 allows for propagation of ultrasound energy.

The display arrangement further comprises a plurality of ultrasonic transducers 106 connected to the cover structure 102 and located at the periphery of the cover structure 102. Accordingly, the ultrasonic transducers 106 are here illustrated as being non-overlapping with an active sensing area of the biometric imaging device formed by the ultrasonic transducers 106 and the cover structure 102. However, the ultrasonic transducers 106 may also be arranged and configured such that they overlap an active sensing area. FIG. 1A illustrates an example distribution of the transducers 106 where the transducers 106 are evenly distributed around the periphery of the cover structure 102 along all sides of the display panel. However, other transducer distributions are equally possible, such as arranging the transducers 106 on one, two or three sides of the display panel, and irregular distributions are also possible.

FIG. 1B is a cross section view of the cover structure 102 where it is illustrated that the ultrasonic transducers 106 are arranged underneath the cover structure 102 and attached to the bottom surface 118 of the cover structure 102. The ultrasonic transducer 106 is a piezoelectric transducer comprising a first electrode 108 and second electrode 110 arranged on opposing sides of a piezoelectric element 112 such that by controlling the voltage of the two electrodes 108, 110, an ultrasonic signal can be generated which propagates into the cover structure 102.

The cover structure 102 has a sloped edge portion 120 which is sloped in relation to a surface plane of the cover structure 102, and wherein the transducers 106 are arranged at a bottom surface 118 of the cover structure 102 opposite a sloped surface of the sloped edge portion 12 such that emitted ultrasound waves are reflected by the sloped surface and into the cover structure 102. The angle of the slope is preferably selected such that the emitted ultrasonic waves are traveling in the in the plane of the cover structure 102 with a minimum of reflections.

The pitch of the transducers may be between half the wavelength of the emitted signal and 1.5 times the wavelength, where the wavelength of the transducer is related to the size of the transducer. For an application where it is known that beam-steering will be required, the pitch may preferably be half the wavelength so that grating lobes are located outside of an active imaging area. A pitch approximately equal to the wavelength of the emitted signal may be well suited for applications where no beam-steering is required since the grating lobes will be close to the main lobe. The wavelength of the transducer should be approximately equal to the size of the features that are to be detected, which in the case of fingerprint imaging means using a wavelength in the range of 50-300 μm. An ultrasonic transducer 106 can have different configurations depending on the type of transducer and also depending on the specific transducer package used. Accordingly, the size and shape of the transducer as well as electrode configurations may vary. It is furthermore possible to use other types of devices for the generation of ultrasonic signals such as micromachined ultrasonic transducers (MUTs), including both capacitive (cMUTs) and piezoelectric types (pMUTs).

Moreover, suitable control circuitry 114 is required for controlling the transducer to emit an acoustic signal having the required properties with respect to e.g. amplitude, pulse shape and timing. However, such control circuitry for ultrasonic transducers is well known to the skilled person and will not be discussed in detail herein.

Each ultrasonic transducer 106 is configured to transmit an acoustic signal ST propagating in the cover structure 102 and to receive a reflected ultrasonic signal SR having been influenced by an object 105, here represented by a finger 105, in contact with the sensing surface 104.

The acoustic interaction signals SR are presently believed to mainly be due to so-called contact scattering at the contact area between the cover structure 102 and the skin of the user (finger 105). The acoustic interaction at the point of contact between the finger 105 and the cover plate 103 may also give rise to refraction, diffraction, dispersion and dissipation of the acoustic transmit signal ST. Accordingly, the interaction signals SR are advantageously analyzed based on the described interaction phenomena to determine properties of the finger 105 based on the received ultrasonic signal. For simplicity, the received ultrasonic interaction signals SR will henceforth be referred to as reflected ultrasonic echo signals SR. In some embodiments, the ultrasonic imaging system is configured to form an image of only a selected target area 107 of the touch surface, which is a selected portion of the entire touch area.

Accordingly, the ultrasonic transducers 106 and associated control circuitry 114 are configured to determine properties of the object 105 based on the received ultrasonic echo signal SR. The plurality of ultrasonic transducers 106 are connected to and controlled by ultrasonic transducer control circuitry 114. The control circuitry 114 for controlling the transducers 106 may be embodied in many different ways. The control circuitry 114 may for example be one central control unit 114 responsible for determining the properties of the acoustic signals ST to be transmitted, and for analyzing the subsequent received ultrasonic echo signal SR. Moreover, each transducer 106 may additionally comprise control circuitry for performing specified actions based on a received command.

The control unit 114 may include a microprocessor, microcontroller, programmable digital signal processor or another programmable device. The control unit 114 may also, or instead, include an application specific integrated circuit, a programmable gate array or programmable array logic, a programmable logic device, or a digital signal processor. Where the control unit 114 includes a programmable device such as the microprocessor, microcontroller or programmable digital signal processor mentioned above, the processor may further include computer executable code that controls operation of the programmable device. The functionality of the control circuitry 114 may also be integrated in control circuitry used for controlling the display panel or other features of the smartphone 100.

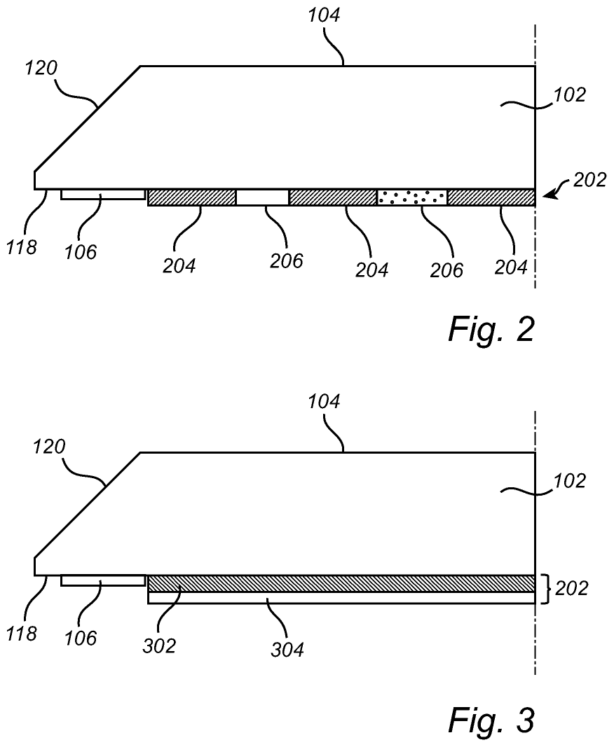

FIG. 2 schematically illustrates a portion of an ultrasonic biometric imaging device 100 comprising: a cover structure 102 having an exposed outer surface 104, wherein at least a portion of the exposed outer surface 104 forms a sensing surface of the ultrasonic biometric imaging device 100; and a plurality of ultrasonic transducers 106 attached to an edge portion of the cover structure 102 and configured to emit an ultrasound wave into the cover structure 102, the cover structure 102 further comprising a reflection reducing layer 202 arranged at the bottom surface 118 of the cover structure 102, wherein the reflection reducing layer 202 is configured to reduce an amplitude of ultrasonic wave reflections at the bottom surface 118 of the cover structure 102.

In the example embodiment illustrated by FIG. 2, the reflection reducing layer 202 comprises a damping layer 202 attached to the bottom surface 118 of the cover structure 102, the damping layer comprising a plurality of first area portions 204 having a first acoustic property, and a plurality of second area portions 206 having a second acoustic property different from the first acoustic property.

The acoustic impedance of the different portions is preferably optimized in each area portion to minimize the value of the reflection coefficient at all sensing distances. For example, in an area close to the transducer 106, the acoustic impedance is preferably as close as possible to the impedance of the cover structure 102. However, further away from the transducer 106, the acoustic impedance could/might be smaller. The acoustic impedance of the damping layer 202 could for example be gradually/continuously reduced with increasing distance from the transducer 106. Such a continuous change could be achieved by gradually changing the density and/or other properties of the damping layer 202 by adding fillers/particles in an epoxy-based material from which the damping layer can be made.

For the damping layer 202, the different portions 204, 206, the size and properties of the different portions may depend on the distance from the transducer 106. In general, close to the transducer 106, the change in incident angle is large, hence the size of the portions is preferably smaller. Further away from the transducer 106, the size of the portions could be larger. Moreover, it should be understood that even though FIG. 2 illustrates a damping layer 202 comprising two different area portions 204, 206, any number of different area portions could be used in order to minimize the reflections at the interface between the cover structure 102 and the damping layer 202.

FIG. 3 schematically illustrates an ultrasonic biometric imaging device where the reflection reducing layer 202 comprises a first acoustic damping layer 302 in contact with the bottom surface 118 of the cover structure 102 and a second acoustic damping layer 304 arranged in contact with the first acoustic damping layer 302, wherein the acoustic properties of the first acoustic damping layer 302 are different than the acoustic properties of the second acoustic damping layer 304. The second acoustic damping layer 304 may for example be an optically clear adhesive (OCA) used for attaching the cover structure 102 to a display panel so that the ultrasonic biometric imaging device 100 is integrated in a display panel of an electronic device. The OCA may for example have a thickness in the range of 50-200 um and the thickness of the damping layer 202 could be up to 1000 um.

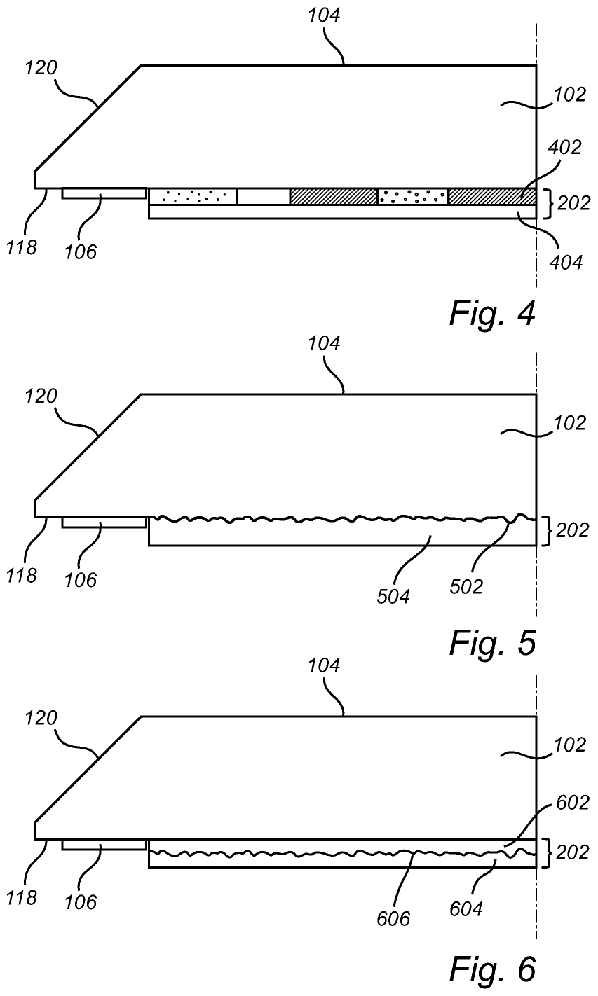

FIG. 4 schematically illustrates an ultrasonic biometric imaging device where the reflection reducing layer 202 comprises a first acoustic damping layer 402 in contact with the bottom surface 118 of the cover structure and a second acoustic damping layer 404 arranged in contact with the first acoustic damping layer 402, wherein at least one of the first and second acoustic damping layers 402, 404 comprises a plurality of first area portions 406 having a first acoustic property, and a plurality of second area portions 408 having a second acoustic property different from the first acoustic property. In the example illustrated by FIG. 4, it is the first acoustic damping layer 402 that comprises the described first and second area portions 406, 408. However, it may equally well be the second acoustic damping layer 404 which comprises such area portions.

FIG. 5 is a schematic illustration of an ultrasonic biometric imaging device 100 where the reflection reducing layer 202 comprises a rough bottom surface 502 of the cover structure 102, and where the roughness of the bottom surface is configured to scatter ultrasonic waves reaching the bottom surface. To achieve the desired scattering, the rough surface 502 is configured to comprise features having a size in the range of 50 μm to 500 μm, which is approximately equal to the acoustic wavelength of the of ultrasonic waves propagating in the cover structure 102. The rough bottom surface 502 may be an irregular surface formed through grinding, sanding or other means of mechanical roughening. It would also be possible to form the rough bottom surface 502 by forming regular or pseudo-random features having the described sizes by means of etching or material deposition.

FIG. 5 further illustrates that the reflection reducing layer 202 comprises an optional acoustic damping layer 504 attached to the rough bottom surface 502 of the cover structure. The first acoustic damping layer would thus further add to the reflection reduction as described above.

FIG. 6 schematically illustrates an ultrasonic biometric imaging device where the reflection reducing layer 202 comprises a first acoustic damping layer 602 in contact with the bottom surface 118 of the cover structure 102 and a second acoustic damping layer 604 arranged in contact with the first acoustic damping layer 602, wherein the acoustic properties of the first acoustic damping layer 602 are different from the acoustic properties of the second acoustic damping layer 604 and wherein an interface 606 between the first and second acoustic damping layer is rough, the roughness of the interface being configured to scatter ultrasonic waves reaching the interface.

In order to efficiently scatter ultrasonic waves, the roughness of the interface 606 comprises features having a size in the range of 50 μm to 500 μm, and as described above, the features may be formed through a mechanical process or through controlled etching or deposition techniques.

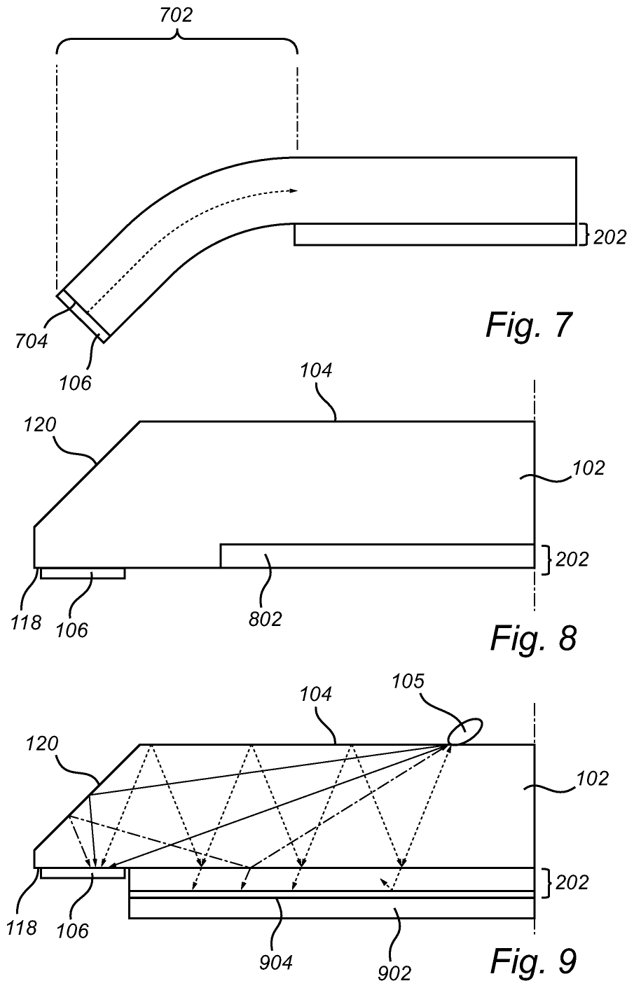

FIG. 7 is a schematic illustration of a biometric imaging device where the cover structure 102 has a curved edge portion 702, and wherein the transducers 106 are arranged at an end portion 704 of the curved edge portion. More specifically, the transducers 106 are here arranged at an end surface 704 of the cover structure 102 such that the ultrasonic waves are emitted into the cover structure 102 and are guided by the curved portion 702 in order to propagate in the plane of the cover structure 102, thereby reaching a sensing area of the sensing surface with a minimum of reflections.

FIG. 8 schematically illustrate an ultrasonic biometric imaging where the cover structure 102 comprises a recess 802 at the bottom surface 118 of the cover structure 102, and wherein the reflection reducing layer 202 is arranged in the recess 802 of the cover structure 102. Thereby, a reflection damping structure 202 can be formed without adding to the overall thickness of the cover structure 102, and a cover structure 102 with a planar bottom surface can be provided which may be advantageous for device integration. Any one of the reflection reducing layers discussed above in relation to the various embodiments may be arranged in a recess, trench or the like of the cover structure.

FIG. 9 schematically illustrates an ultrasonic biometric imaging device further comprising a display panel 902 attached to a bottom surface 904 of the reflection reducing structure 202. FIG. 9 further illustrates reflected ultrasonic waves in the cover structure 102, where reflections reaching the bottom surface 118 of the cover structure 102 and into the reflection reducing structure are dampened or deduced before reaching the display panel 902 where a portion are reflected back towards the cover structure. Accordingly, ultrasonic signals leaving the cover structure and reaching the underlying display panel at an angle where they are reflected are passing through the reflection reducing structure 202 twice before again reaching the cover structure 102.

Even though the invention has been described with reference to specific exemplifying embodiments thereof, many different alterations, modifications and the like will become apparent for those skilled in the art. Also, it should be noted that parts of the ultrasonic biometric imaging device may be omitted, interchanged or arranged in various ways, the device yet being able to perform the functionality of the present invention.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage.

1. An ultrasonic biometric imaging device comprising:
a cover structure having an exposed outer surface, wherein at least a portion of the exposed outer surface forms a sensing surface of the ultrasonic biometric imaging device; and
a plurality of ultrasonic transducers attached to an edge portion of the cover structure and configured to emit an ultrasound wave into the cover structure;
the cover structure further comprising a reflection reducing layer arranged at a bottom surface of the cover structure and adjacent to the ultrasonic transducers, wherein the reflection reducing layer is configured to reduce an amplitude of ultrasonic wave reflections at the bottom surface of the cover structure.

2. The ultrasonic biometric imaging device according to claim 1, wherein the reflection reducing layer comprises a damping layer attached to the bottom surface of the cover structure, the damping layer comprising a plurality of first area portions having a first acoustic property, and a plurality of second area portions having a second acoustic property different from the first acoustic property.

3. The ultrasonic biometric imaging device according to claim 1, wherein the reflection reducing layer comprises a damping layer attached to the bottom surface of the cover structure, the damping layer having an acoustic impedance similar to the acoustic impedance of the cover structure in a region adjacent the ultrasonic transducers, and where the acoustic impedance of the damping layer is decreasing with increasing distance from the ultrasonic transducers.

4. The ultrasonic biometric imaging device according to claim 1, wherein the reflection reducing layer comprises a first acoustic damping layer in contact with the bottom surface of the cover structure and a second acoustic damping layer arranged in contact with the first acoustic damping layer, wherein the acoustic properties of the first acoustic damping layer are different than the acoustic properties of the second acoustic damping layer.

5. The ultrasonic biometric imaging device according to claim 4, wherein the second acoustic damping layer is an optically clear adhesive layer.

6. The ultrasonic biometric imaging device according to claim 1, wherein the reflection reducing layer comprises a first acoustic damping layer in contact with the bottom surface of the cover structure and a second acoustic damping layer arranged in contact with the first acoustic damping layer, wherein at least one of the first and second acoustic damping layer comprises a plurality of first area portions having a first acoustic property, and a plurality of second area portions having a second acoustic property different from the first acoustic property.

7. The ultrasonic biometric imaging device according to claim 1, wherein the reflection reducing layer comprises a rough bottom surface of the cover structure, the roughness of the bottom surface being configured to scatter ultrasonic waves reaching the bottom surface.

8. The ultrasonic biometric imaging device according to claim 7, wherein the reflection reducing layer further comprises an acoustic damping layer attached to the rough bottom surface of the cover structure.

9. The ultrasonic biometric imaging device according to claim 1, wherein the reflection reducing layer comprises a first acoustic damping layer in contact with the bottom surface of the cover structure and a second acoustic damping layer arranged in contact with the first acoustic damping layer, wherein the acoustic properties of the first acoustic damping layer are different from the acoustic properties of the second acoustic damping layer and wherein an interface between the first and second acoustic damping layer is rough, the roughness of the interface being configured to scatter ultrasonic waves reaching the interface.

10. The ultrasonic biometric imaging device according to claim 1, wherein the transducers are arranged in contact with the cover structure so that emitted ultrasound waves are propagating in the plane of the cover structure.

11. The ultrasonic biometric imaging device according to claim 1, wherein the cover structure has a curved edge portion, and wherein the transducers are arranged at an end portion of the curved edge portion.

12. The ultrasonic biometric imaging device according to claim 1, wherein the cover structure has a sloped edge portion with a slope in relation to a surface plane of the cover structure, and wherein the transducers are arranged at a bottom surface of the cover structure opposite the sloped surface of the sloped edge portion such that emitted ultrasound waves are reflected by the sloped surface and into the cover structure.

13. The ultrasonic biometric imaging device according to claim 1, wherein the cover structure comprises a recess the bottom surface, and wherein the reflection reducing layer is arranged in the recess of the cover structure.

14. The ultrasonic biometric imaging device according to claim 13, wherein the reflection reducing layer is arranged in the recess of the cover structure such that the reflection reducing layer and the cover structure forms a planar bottom surface.

15. The ultrasonic biometric imaging device according to claim 1, further comprising a display panel attached to a bottom surface of the reflection reducing layer.

16. The ultrasonic biometric imaging device according to claim 1, wherein the cover structure is a display cover glass.

17. The ultrasonic biometric imaging device according to claim 1, wherein the reflection reducing layer is located in an area of the surface structure opposite the sensing surface.

18. The ultrasonic biometric imaging device according to claim 1, wherein the reflection reducing layer is covering a major portion of the bottom surface of the cover structure.
